(19) United States
(12) Patent Application Publication
(10) Pub. No.: US 2018/0088657 A1
(43) Pub. Date: Mar. 29, 2018

(54) POWER SAVING FOR MULTIMEDIA SERVER STORAGE

(71) Applicant: Lenovo (Singapore) Pte. Ltd., Singapore (SG)

(72) Inventors: Robert James Kapinos, Durham, NC (US); Scott Wentao Li, Cary, NC (US); Russell Speight VanBlon, Raleigh, NC (US); Timothy Winthrop Kingsbury, Cary, NC (US)

(21) Appl. No.: 15/276,303

(22) Filed: Sep. 26, 2016

(51) Int. Cl. G06F 1/32; G06F 12/0864

(52) U.S. Cl. CPC G06F 1/3275; G06F 2212/6032; G06F 12/0864

(57) ABSTRACT

One embodiment provides a method, including: receiving, using a processor, a multimedia file; identifying, using the processor, data of the multimedia file having a characteristic; caching, in a persistent cache memory, the data of the multimedia file having the characteristic; storing, in a long term storage device, at least the remaining data of the multimedia file; associating, using the processor, the data of the media file having the characteristic and the remaining data of the multimedia file; and thereafter powering down the long term storage device. Other aspects are described and claimed.

### BACKGROUND

Video and music servers have requirements such as a need for low sequential latency, large storage capacity, and high redundancy. Low latency is needed to keep media content playing smoothly and for fast catalog browsing. Video and audio files contain many megabytes per second of data, making a large storage capacity necessary. The expense of building and populating a multimedia server makes losses of data a large hazard. Consequently, redundancy is a concern.

Typically these requirements are met by RAID storage (redundant array of inexpensive disks), e.g., inexpensive rotational storage disks. RAID storage is cheap and reliable. RAID storage, however, also has the deficiencies, e.g., being power inefficient and short lived due to constant running of motors and moving of array heads.

Cost scalability is an issue. Very Large RAID arrays can be cost effectively built of high performance server parts, since the overhead of redundant power, floor space, connectivity, maintenance, and air conditioning costs far more than better drive hardware. This cost model does not scale down to the home or small business multimedia server, however, where the overhead cost is very low in comparison to the cost of the base hardware and replacements. For example, high performance RAID drives may be about double the cost of ordinary RAID drives.

### BRIEF SUMMARY

In summary, one aspect provides a method, comprising: receiving, using a processor, a multimedia file; identifying, using the processor, data of the multimedia file having a characteristic; caching, in a persistent cache memory, the data of the multimedia file having the characteristic; storing, in a long term storage device, at least the remaining data of the multimedia file; associating, using the processor, the data of the media file having the characteristic and the remaining data of the multimedia file; and thereafter powering down the long term storage device.

Another aspect provides a device, comprising: a persistent cache memory; a long term storage device; a controller comprising a processor; and a program that is executed by the processor to: receive a multimedia file; identify data of the multimedia file having a characteristic; cache, in the persistent cache memory, the data of the multimedia file having the characteristic; store, in the long term storage device, at least the remaining data of the multimedia file; associate the data of the media file having the characteristic and the remaining data of the multimedia file; and thereafter power down the long term storage device.

A further aspect provides a program product, comprising: a computer readable storage device having code stored therewith, the code being executable by a processor and comprising: code that receives a multimedia file; code that identifies data of the multimedia file having a characteristic; code that caches, in a persistent cache memory, the data of the multimedia file having the characteristic; code that stores, in a long term storage device, at least the remaining data of the multimedia file; code that associates the data of the media file having the characteristic and the remaining data of the multimedia file; and code that thereafter powers down the long term storage device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates an example multimedia file storage system.

FIG. 3 illustrates an example multimedia file storage method.

FIG. 4 illustrates an example multimedia file retrieval method.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

A method is needed to allow the drives or a RAID storage arrangement to rest, e.g., for power efficiency, for extending the life of the physical components, etc. Moreover, in the context of a multimedia file server, powered down RAID storage has the additional drawback of high latency (or the order of tens of seconds). This is due in part to the time it takes the drive to spin up and for the heads to move to the appropriate location to retrieve the requested multimedia file data.

Conventional approaches to multimedia file storage provide a RAID controller that stops the drives when they are not being accessed. This is done for power savings. This approach, however, creates a problem of an 8-12 second access latency. This is unsuitable for multimedia use.

Hybrid storage drives exist. For example, some multimedia file storage arrangements couple fast access, e.g., solid state drives, with inexpensive rotational storage drives. The fast access drives store often accessed files on a solid state cache, whereas the larger rotational storage drives are permitted to rest on the basis that files residing thereon will not often be requested. This requires a caching algorithm or technique to be applied in an attempt to identify or predict the often accessed multimedia files such that these files may be stored in the fast access drive, leaving the other multimedia files in the slower rotational storage, which may be powered down.

Such caching mechanisms are based on most-used files. These algorithms are poorly suited for multimedia files. Also, the storage capacity of hybrid drives is not sufficient for well populated video servers, i.e., the solid state cache is often small in terms of storage capacity such that they cannot store an entire media library, forcing decisions as to which files to retain in fast access storage.

An embodiment leverages the use cases and attributes of multimedia files to make a hybrid RAID storage system that has excellent power characteristics, i.e., a large amount of the system may be powered down (and duty cycles on the main, rotational storage disks reduced), while retaining low latency for servicing multimedia file requests. An embodiment provides a multimedia file storage technique that allows the use of ordinary, inexpensive rotational disk drives for storage, versus ‘RAID rated’ drives, increases the lifespan of the system components, and lowers the chance of failure.

An embodiment accomplishes this by providing a system that splits multimedia files to intelligently cache part of the multimedia file on a fast access disk (e.g., a solid state drive, a non-volatile memory, a battery backed up RAM, etc.), while storing the remaining data of the multimedia file (the entire file or part thereof) on inexpensive and higher latency rotational storage, which then may be in a default low power state until needed.

An embodiment utilizes knowledge of multimedia file characteristics that makes it possible to identify which part(s) of each multimedia file should be stored on the fast access cache, as well as which part(s) of the multimedia files should be placed in the rotational storage of the system.

Multimedia files have the following attributes that are utilized to implement such a technique. Often accessed metadata of a multimedia file is placed at the beginning of the multimedia file. This often accessed metadata, e.g., titles, runtime information, beginning part of a movie file, etc., is used on the order of 100 times more frequently than the rest of the multimedia file.

Additionally, multimedia files are characterized by the fact that users start playback either at the beginning of the multimedia data (i.e., the start of a movie file, the start of an audio file, etc.) or at a resume point (where the user previously stopped, paused or bookmarked the multimedia file), and users move sequentially or in large steps through multimedia file, i.e., users do not tend to skip to very many different parts of the multimedia file in a random fashion.

Multimedia files also play more slowly than they are retrieved. For example, the actual consumption rate of compressed video data is about 20:1 in terms of storage retrieval speed to playback speed, even on slow media such as DVD and Blu-ray Disc®. For RAID storage systems this ratio can be as high as 250:1.

Furthermore, multimedia files on a server are usually written once. They are very seldom altered.

All of these characteristics of multimedia files, including users typical access patterns, allow for an embodiment to intelligently cache a certain portion of each multimedia file such that the part(s) of the multimedia file that are needed quickly are stored on low latency memory and the part(s) of a multimedia file that may thereafter be needed (e.g., the remainder of a movie file) are stored in higher latency, rotational storage, which may be powered down until needed.

The illustrated example embodiments will be best understood by reference to the figures. The following description is intended only by way of example, and simply illustrates certain example embodiments.

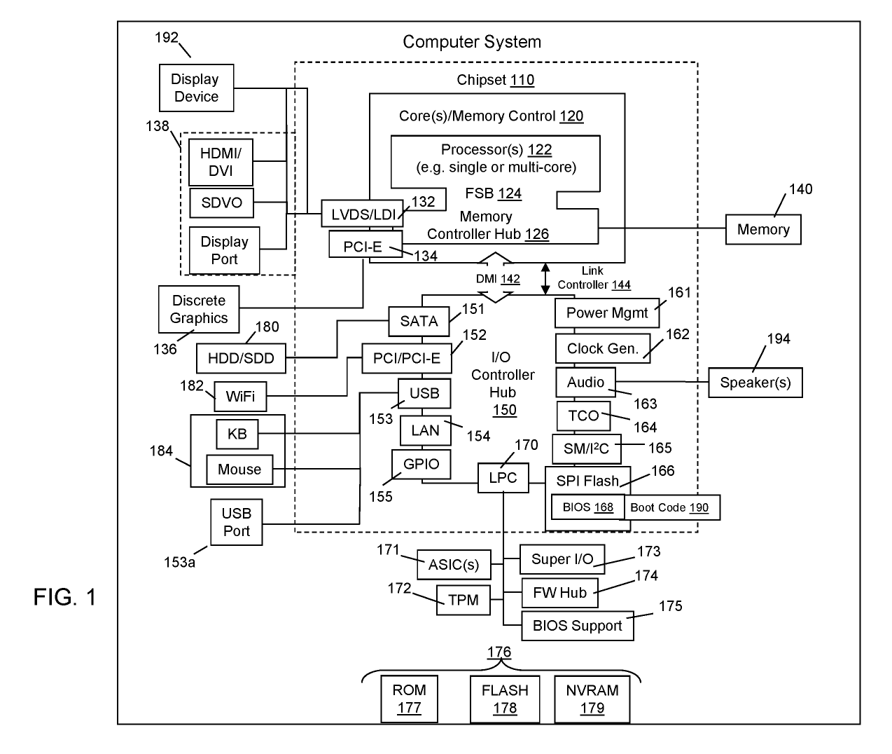

While various other circuits, circuitry or components may be utilized in information handling devices, FIG. 1 depicts a block diagram of an example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 110 includes a core and memory control group 120 and an I/O controller hub 150 that exchanges information (for example, data, signals, commands, etc.) via a direct management interface (DMI) 242 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture. One or more processors 122 comprise internal arithmetic units, registers, cache memory, busses, I/O ports, etc., as is well known in the art.

In FIG. 1, the memory controller hub 126 interfaces with memory 140 (for example, to provide support for a type of RAM that may be referred to as “system memory” or “memory”). The memory controller hub 126 further includes a low voltage differential signaling (LVDS) interface 132 for a display device 192 (for example, a CRT, a flat panel, touch screen, etc.). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, etc., 180), a PCI-E interface 152 (for example, for wireless connections 182), a USB interface 153 (for example, for devices 184 such as a digitizer, keyboard, mice, cameras, phones, microphones, storage, biometric data capture device, other connected devices, etc.), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support. USB interface 153 may include a physical port 153a, e.g., into which a connectable or pluggable storage device is placed.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

Information handling device circuitry, as for example outlined in FIG. 1, may be used in devices such as a computer that includes a controller and/or control function for a RAID storage system. For example, the circuitry outlined in FIG. 1 may be included in whole or in part into a control device that operates a solid state cache memory device and a rotational RAID array to facilitate multimedia file storage, as described herein.

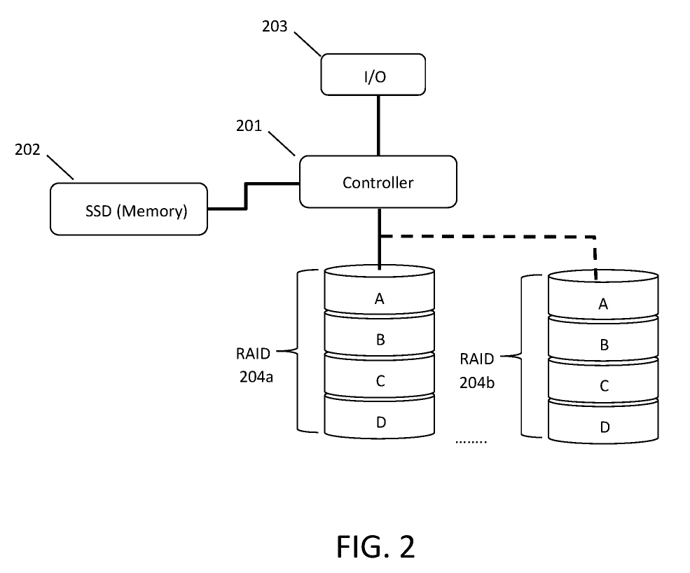

Referring now to FIG. 2, an embodiment includes a RAID storage system that includes, but is not necessarily limited to, the following components. A high redundancy RAID array 204a, 204b, (e.g., a RAID-5, RAID-6, or RAID-10 array) of inexpensive rotational storage disks (here denoted “A,” “B,” “C,” and “D”). The rotational storage disks A-D (here shown replicated once to illustrate redundancy within the system) may be powered down when not needed, as further described herein.

A fast-access, always-on redundant caching area 202 is provided and linked to the RAID controller 201. This cache memory 202 may be sized approximately in a ratio of 1:200 (for video) or 1:50 (for audio) to the inexpensive rotational storage 204a, 204b. The RAID controller 201 is enabled for a variety of intelligent caching mechanisms, as is described further herein, for responding to requests, e.g., from a media player application of a remote device, received via input/output link 203.

In practice, an embodiment detects that sectors being written to the inexpensive rotational storage 204a, 204b contain multimedia information, which is then duplicated (in part) on the fast access cache drive 202, which as illustrated may be formed of a solid state memory device. An embodiment also detects, via the controller 201, when multimedia sectors are being read, e.g., from the fast access cache 202, and acts accordingly to the access, e.g., activates the rotational storage device(s) 204a, 204b for further multimedia data retrieval.

As may be appreciated, the parts of the multimedia file that are accessed often and thus need to be or should be stored in the fast access cache memory 202 may be identified based on a characteristic. For example, a characteristic of multimedia data that counsels caching in the fast access cache memory 202 is that the data is stored in the beginning sectors of the multimedia file. Various types of multimedia data may be so characterized, e.g., metadata, titles, first moments, etc., such that these parts of the multimedia file are always held in fast access storage 202.

In contrast, the parts of the multimedia file that are not characterized as often accessed, i.e., parts that are infrequently accessed, are held in reserve, i.e., held in rotational storage 204a, 204b until they are needed, then fetched at a fast burst rate. Enough transitional material is held in the fast access storage device 202 to allow very high latency of reserve storage 204a, 204b. The data rates of moving from reserve storage 204a, 204b to fast access storage 202 are such that the on cycle of reserve storage 204a, 204b remains very low. This saves power and increases the lifespan of the devices and components of the reserve storage 204a, 204b.

A controller, e.g., controller 201, is programmed to store a redundant copy of the metadata headers for any multimedia file receive on the caching device 202, as well as on the main array devices 204a, 204b. For each multimedia file of the system, i.e., each multimedia file in a library stored on long term storage devices 204a, 204b, the controller allocates a small buffer (e.g., storage space for 12-15 seconds) for part of the multimedia file on the caching device 202, as well as on the main array devices 204a, 204b.

The main disc array devices 204a, 204b are normally off. In an embodiment, the main array devices 204a, 204b turn on only when data is needed from the main disc array. A sequential request to play a multimedia file causes streaming of the multimedia file from the buffer on the cache drive 202. At the same time, the main array 204a, 204b is awakened and the controller 201 copies more of the multimedia file data from the main array 204a, 204b to the cache drive 202. After the copy action, the main array 204a, 204b goes back to sleep or low power mode, while playback continues from the cache drive 202.

A resume request for a multimedia file causes a copy of more of the multimedia file data from the main array 204a, 204b to the cache drive 202. After the copy action, the main array 204a, 204b goes back to sleep while playback continues from the cache drive 202. Thus, an embodiment may cache not only the beginning part of the multimedia file, but also other parts that are often accessed or often accessed in a particular context, e.g., multimedia file data associated with a pause point, stopping point, and/or bookmarked point of the multimedia file.

Periodic garbage collection techniques may be utilized to remove data off of the cache drive 202. If the entire multimedia file is stored as a copy on long term storage devices 204a, 204b, no write action is required prior to removing multimedia file data from the cache device 202. Thus, redundant multimedia files that have not been accessed in a time, e.g., based on a usage profile, may have the part of their data stored on the fast access cache device 202 removed. A secondary caching algorithm may be implemented by the controller 201 to keep redundant cached copies of the file system sectors and small non-multimedia files on the cache drive 202. In an embodiment, certain full multimedia files may be retained on the fast access cache 202 and thus used for reconstruction purposes.

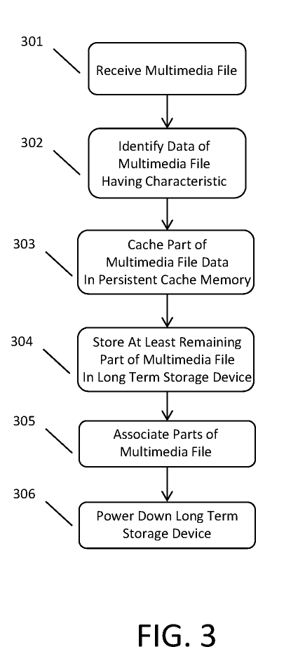

Turning to FIG. 3, an embodiment provides a method including receiving a multimedia file at 301 and identifying data of the multimedia file having a characteristic at 302. For example, for each multimedia file received for storage on the long term/rotational storage area, data selected from the group consisting of multimedia file metadata, title data, and lead in multimedia data (e.g., opening moments, resume point, bookmarked, etc.) is identified as having an often accessed characteristic at 302. This multimedia data is cached in a persistent cache memory at 303, e.g., a fast access SSD memory device, such that it may be retrieved with very low latency.

At the same time, an embodiment offers massive storage capability using inexpensive disks, e.g., in a RAID array. Therefore, an embodiment stores, in a long term rotational storage devices, at least the remaining data of the multimedia file at 304. That is, at the very least, the remainder of the multimedia file is stored at 304 in rotational storage. However, as described herein, the entire multimedia file may be stored in rotational storage, with a redundant copy of part(s) of the multimedia file being cached in the fast access cache.

In order to facilitate fast access and continuity, an association between the data of the media file having the characteristic (and cached in the fast access cache) and the remaining data of the multimedia file (stored in the long term, rotational storage device(s)) is created at 305. For example, a logical storage location of the remaining data of the multimedia file is retained for each part of multimedia file data stored in the fast access cache. This permits an embodiment to begin providing the data of the multimedia file immediately from the fast access cache, whereas the remainder of the file may be located and retrieved form the long term rotational storage.

As such, an embodiment permits the long term rotational storage device(s) to be powered down at 306. This permits power savings and reduces operational uptime for this part of the system, reducing power consumption and wear and tear on these system components.

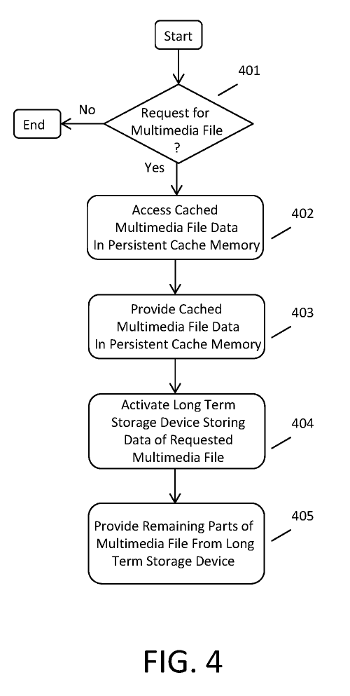

Referring to FIG. 4, if an embodiment receives a request for the multimedia file, as determined at 401, an access is made to the persistent cache memory at 402 in order to locate the data of the multimedia file requested in the fast access cache. Therefore, an embodiment may immediately (or with very low latency) provide the data of the multimedia file to a multimedia playback device, as indicated at 403. For example, a user may begin playing a requested multimedia file by streaming its opening moments from the fast access cache.

In the meantime, an embodiment activates the long term storage device at 404, e.g., based on the logical association of the data of the multimedia file that is cached and the remaining data in the long term storage device(s). An embodiment thereafter provides the remaining data of the multimedia file to the multimedia playback device from the long term storage device, as indicated at 405.

It is noted here that an embodiment may provide only enough of a multimedia file to cover a set viewing time and revisit that file for transfer again later as the user moves along in his or her watching. In practice, chunks of about 25 minutes have been shown to be a good choice for video piece size for balancing power management and cache data size. A smart controller can bunch the transfer of future multimedia file data chunks together during the same array awake time for better power savings.

Thus, an embodiment facilitates caching of often accessed parts of multimedia files in a fast access hardware device, e.g., a solid state memory device, whereas the vast majority of the multimedia file data is stored within inexpensive rotational disk space. This permits powering down (reducing power) of the inexpensive disks, without negatively impacting the response time of the multimedia server system.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, using a processor, a multimedia file;
identifying, using the processor, data of the multimedia file having a characteristic;
caching, in a persistent cache memory, the data of the multimedia file having the characteristic;
storing, in a long term storage device, at least the remaining data of the multimedia file;
associating, using the processor, the data of the media file having the characteristic and the remaining data of the multimedia file; and
thereafter powering down the long term storage device.

2. The method of claim 1, wherein the data of the multimedia file having the characteristic comprises data selected from the group consisting of multimedia file metadata, title data, and multimedia data.

3. The method of claim 1, wherein the caching, in the persistent cache memory, of the data of the multimedia file having the characteristic comprises storing a first part of the multimedia file in a solid state drive.

4. The method of claim 3, wherein the storing, in the long term storage device, of the at least the remaining data of the multimedia file comprises storing a second part of the multimedia file in a rotational storage device.

5. The method of claim 1, wherein the characteristic comprises an association between multimedia data of the multimedia file and a resume point.

6. The method of claim 1, wherein the receiving a multimedia file comprises receiving a plurality of multimedia files, and wherein data of each of the plurality of multimedia files having the characteristic are cached in a persistent cache memory.

7. The method of claim 1, further comprising:
receiving a request for the multimedia file;
accessing the persistent cache memory;
providing the data of the multimedia file having the characteristic to a multimedia playback device;
activating the long term storage device; and
thereafter providing at least a portion of the remaining data of the multimedia file from the long term storage device.

8. The method of claim 1, wherein the data of the multimedia file having the characteristic is maintained in the persistent cache memory.

9. The method of claim 1, wherein data having the characteristic of an entire library of multimedia files contained in the long term storage device are maintained in the persistent cache memory.

10. The method of claim 1, wherein the at least the remaining data of the multimedia file comprises an entire copy of the multimedia file.

11. A device, comprising:
a persistent cache memory;
a long term storage device;
a controller comprising a processor; and
a program that is executed by the processor to:
receive a multimedia file;
identify data of the multimedia file having a characteristic;
cache, in the persistent cache memory, the data of the multimedia file having the characteristic;
store, in the long term storage device, at least the remaining data of the multimedia file;
associate the data of the media file having the characteristic and the remaining data of the multimedia file; and
thereafter power down the long term storage device.

12. The device of claim 11, wherein the data of the multimedia file having the characteristic comprises data selected from the group consisting of multimedia file metadata, title data, and multimedia data.

13. The device of claim 11, wherein the data of the multimedia file having the characteristic comprises a first part of the multimedia file, and wherein the persistent cache memory comprises a solid state drive.

14. The device of claim 13, wherein the at least the remaining data of the multimedia file comprises a second part of the multimedia file, and wherein the long term storage device comprises a rotational storage device.

15. The device of claim 11, wherein the characteristic comprises an association between multimedia data of the multimedia file and a resume point.

16. The device of claim 11, wherein the multimedia file comprises a plurality of multimedia files, and wherein data of each of the plurality of multimedia files having the characteristic are cached in a persistent cache memory.

17. The device of claim 11, wherein the processor executes the program to:
receive a request for the multimedia file;
access the persistent cache memory;
provide the data of the multimedia file having the characteristic to a multimedia playback device;
activate the long term storage device; and
thereafter provide at least a portion of the remaining data of the multimedia file from the long term storage device.

18. The device of claim 11, wherein the data of the multimedia file having the characteristic is maintained in the persistent cache memory.

19. The device of claim 11, wherein data having the characteristic of an entire library of multimedia files contained in the long term storage device are maintained in the persistent cache memory.

20. A program product, comprising:
a computer readable storage device having code stored therewith, the code being executable by a processor and comprising:
code that receives a multimedia file;
code that identifies data of the multimedia file having a characteristic;
code that caches, in a persistent cache memory, the data of the multimedia file having the characteristic;
code that stores, in a long term storage device, at least the remaining data of the multimedia file;
code that associates the data of the media file having the characteristic and the remaining data of the multimedia file; and
code that thereafter powers down the long term storage device.
